(19) United States
(12) Patent Application Publication
(10) Pub. No.: US 2008/0025504 A1
(43) Pub. Date: Jan. 31, 2008

(54) Computer or digital device data encryption/decryption performed by using a random analog source

(75) Inventors: Robert James Rapp, Lake Forest, CA (US); Andrew David Hospodor, Los Gatos, CA (US)

Correspondence Address: ROBERT JAMES RAPP, 23333 RIDGE ROUTE DRIVE #126, LAKE FOREST, CA, 92630, US

(73) Assignees: Robert J. Rapp; Andrew D. Hospodor

(21) Appl. No.: 11/602,425

(22) Filed: Nov. 20, 2006

Related U.S. Application Data
(60) Provisional application No. 60/739,714, filed on Nov. 23, 2005.

(51) Int. Cl. H04L 9/00

(52) U.S. Cl. 380/46

(57) ABSTRACT

A digital data encryption methodology that uses truly random data rather than pseudo-random data generated by conventional binary computer algorithms to encrypt and decode computer data is made by converting a natural source of random data from its native analog domain to digital through an Analog to Digital converter creating a set of random encryption “keys”. Once a truly random source is recorded in a digital format it may be distributed to a set of trusted devices for use in encoding or decoding data sent to or received from compatible trusted devices. In order for compatible devices to communicate a decoding device would have to start decoding in-phase with the data as encoded by the device that sent the data. The encryption can be further enhanced by varying the access sequence of the recorded keys used for encryption and required for decryption: i.e.: sequence patterns could vary base on patterns that only 2 devices know of, or could be based on time or other pre-determined sequences. This methodology also is extended by combining random data with public key encryption methodologies. A secure Key server is also used to distribute, configure and maintain a data base that correlates the configuration & access requirements of a plurality of electronic devices.

### CROSS REFERENCE TO RELATED APPLICATIONS

This application is entitled to the benefit of Provisional Patent Application No. 60/739,714 with a filing date of Nov. 23, 2005 by the same inventors Robert J. Rapp and Andrew D. Hospodor, customer number 41400.

### REFERENCES CITED

Hellman, Martin E.; Diffie, Bailey W.; Merkle, Ralph C., Cryptographic apparatus and method, U.S. Pat. No. 4,200,770, Apr. 29, 1980.

Fagen, M. D. ed., A History of Engineering and Science in the Bell System: National Service in War and Peace (1925-1975), Murray Hill, N.J.: Bell Lab, p 296-317.

Bennett, William R., Fellow, IEEE, “Secret Telephony as a Historical Example of Spread-Spectrum Communications,” IEEE Transactions on Communications, Vol. COM-31, No. 1, January 1983, p 99.

### BACKGROUND OF THE INVENTION

Protecting data from being stolen or compromised is of paramount importance, threats to the security abound in consumer, military, and government sectors as the resources available to computer hackers today enables them to defeat the most complex encryption technologies rapidly.

The encryption of computer data is typically performed by using computer generated codes that generate pseudo-random patters that are used to encode and decode data. Binary equations combined with initial patterns (commonly known as keys) are used to compute numbers that when combined with computer data through binary functions encrypt that data. Typically the pseudo-random data is XORed with standard computer data in the encryption process. This approach is based on computations with binary numbers, some number of binary bits, binary equations, and encryption keys; it thus provides a solution with a finite number of permutations, and is therefore vulnerable to attacks when extensive computer resources are applied.

Another frequently used encryption technology is commonly known as the Diffie Hellman key exchange, it is briefly described below. A simple internet search on Diffie Hellman yields numerous descriptions of this technique.

The Diffie Hellman system works as follows:

Two individuals Alice & Bob wish to keep messages sent to each other secret & decide to encrypt their communications. First they agree to use a prime number “P” and a “generator” number “G” to use in their encryption calculations. Furthermore Alice & Bob pick secret numbers; lets say that Alice's secret number is “R” and Bob's is “S”.

Alice computes X=G^{R} mod P, then sends X to Bob

Bob computes Y=G^{S} mod P, then sends Y to Alice

Modulus Arithmetic:

The result from Modulus arithmetic is the remainder left after dividing two numbers: For X=G^{R} mod P; X is the remainder left after dividing G^{R} by P. For example to calculate 25 mod 10: divide 25 by 10 & determine the remainder: from grade school math: 10 goes into 25 two times with 5 left over; Thus 25 mod 10=5.

At this point in time both Alice & Bob know P, G, X, and Y. Not only that but in public key cryptography P, G, X, & Y are openly shared, an eavesdropper may know each of these numbers. When P is a large prime number a hacker wishing to decode a message would have to perform massive numbers of calculations, although the hacker would eventually decrypt the message. When P, G^{R}, & G^{S} are sufficiently large the process of breaking the Diffie Hellman code requires Trillions of calculations; something that can dissuade even the most dedicated hacker. However, any system based on Pseudo Random Numbers (those generated through multiplication and division of Prime numbers) will have telltale patterns or cycles that can be exploited by hackers.

The invention discussed in this patent relates to a digital data encryption methodology & systems that use truly random data rather than by using pseudo-random data generated by conventional binary computer algorithms or by using a conventional public key encryption technology like Diffie Hellman. The invention encrypts and decodes computer data that is made by converting a natural source of random data from its native analog domain to digital through an Analog to Digital converter creating a set or series of random encryption “keys”. Once a truly random source is recorded in a digital format it may be distributed to a set of trusted devices for use in encoding or decoding data sent to or received from compatible trusted devices. In order for compatible devices to communicate a decoding device would have to start decoding in-phase with the data as encoded by the device that sent the data.

The encryption could be further enhanced by varying the access sequence of the recorded keys used for encryption and required for decryption: i.e.: sequence patterns could vary based on patterns that only 2 devices know of, could be based on time, or other pre-determined sequences.

Alternatively the random data from the truly random data source may be used in conjunction with commonly used encryption methods such as Diffie Hellman. In this case the secret numbers used in calculations could be simply picked from the random data & then used in the encryption process. Furthermore two trusted devices could use a modified public key or “Diffie Hellman” schema by sharing some of the other parameters prior to their deployment.

Summary/Description:

The invention discussed in this patent relates to a digital data encryption methodology & systems that uses truly random data rather than pseudo-random data generated by conventional binary computer algorithms. The invention encrypts and decodes computer data that is made by converting a natural random data source from its native analog domain into digital through an Analog to Digital converter creating a set or series of random encryption “keys”. Once a truly random source is recorded in a digital format it may be distributed to a set of trusted devices for use in encoding or decoding data sent to or received from compatible trusted devices. In order for compatible devices to communicate a decoding device would have to start decoding in-phase with the data as encoded by the device that sent the data. An early example is the SIGSALY encryption scheme used by Franklin D. Roosevelt and Winston Churchill during World War II. Developed by Bell Labs in 1941, the first SIGSALY electronics used a random noise source from a mercury arc vapor lamp to modulate voice communication. The resulting buzzing sound could not be deciphered without an exact copy of the noise source, and because it was random, there was literally no chance that the enemy forces could decrypt SIGSALY. While the buzzing was detectable, it provided no more intelligence than the theme song of the Green Hornet radio broadcast.

The encryption could be further enhanced by varying the access sequence of the recorded keys used for encryption and required for decryption: i.e.: sequence patterns could vary based on patterns that only 2 devices know of, could be based on time, or other pre-determined sequences.

Alternatively the random data from the truly random data source may be used in conjunction with commonly used encryption methods such as Diffie Hellman. In this case the secret numbers used in calculations could be simply picked from the random data & then used in the encryption process. Furthermore two trusted devices could use a modified public key or “Diffie Hellman” schema by sharing some of the other parameters prior to their deployment.

Various natural processes are random or generate random noise. In boiling water, for example, of a natural random processes include the sound, location, and sequence of bubble formation is random. Another example is the decay of atomic particles. Importantly, these natural processes are analog; they vary continuously and are not discrete.

Computer systems are discrete, a single bit can only be a 1 or a 0; a single bit cannot be further divided. Analog systems are not discrete as they continuously vary, at each moment a value required to represent the system is not discrete. Digital systems can only approximate analog; some round off error is inevitable.

Given the differences between naturally generated random data and computer generated pseudo-random data, a computer system can never predict with 100% certainty/accuracy the response of an analog system, and therefore can never use binary arithmetic to decode data encrypted by using random analog data. Outside of key corruption (stealing or otherwise obtaining the key surreptitiously) the only way to decode data encrypted by a truly random system is to have access to the same set of recorded random data and apply the keys in the identical sequence.

This is true even when (as described within) truly random analog data is digitized through an Analog to Digital converter as each subsequent sample of analog data cannot be predicted through a binary sequence or calculation: The value of each analog random data sample is only stored as a digital value, how the system changes from moment to moment is not based on a binary system.

One implementation of using a random analog data source begins by sampling the decay of a radioactive cesium source with an Analog to Digital converter and storing this output in a digital storage medium. By XORing the random analog data stream with the real data stream, the contents of the real data stream is encoded. To decode this data simply XOR the encoded data stream with the same digitized random analog data stream.

The XOR function is the simplest way to perform such an encode/decode processes, yet other digital calculations may be used to encode & decode data. Note the XOR in FIG. 6: the output is generated by following the truth table; also if one of the inputs is XORed with the output, the other original input value is generated.

As mentioned earlier, such an encryption methodology could be further enhanced by varying the access sequence of the random analog data stream (encryption keys) used for encryption and required for decryption; the sequence patterns could vary based on patterns that only 2 devices know of, could be based on time, or other pre-determined sequences. Furthermore each different random signal recording would provide a unique encryption keys.

Also as mentioned earlier the random analog data stream may be used as a source of the secret numbers used in public key encryption techniques (techniques such as “Diffie Hellman”) or be used in a modified encryption schema implemented in a similar way to a public key encryption technique by sharing some of the other parameters (the prime number P, or generator number G) prior to their deployment.

One significant attribute of this invention is the recording & digitizing of a continuously varying truly random data source that is later used to encrypt or decrypt data. Sets of such recordings could be stored on a computer system that sources random keys to trusted devices, such a machine is a “key server”. The key server would contain a multitude of digitized random data recordings that could be used in a multitude of ways to dispense keys to trusted devices. Natural sources of truly random data include, yet are not limited to recording sounds, random visual stimuli, random location based information, or random timing information. Truly random sound sources include the sound from a mercury vapor arc lamp or boiling water. Truly random visual stimuli include the locations flashing of a multitude of fire flies in a confined space, the location of bubble formation in a pot of boiling water, or the locations of a multitude of sardines swimming in a water column (contained in a confined space in a large aquarium); Truly random location based information include recording the location of impacts of water droplets falling onto an area, or the landing locations of a multitude of flies landing on surface coated with an attractant (like sugar); Truly random timing based information include the timing of radiation impacting a radiation sensor, the timing between keystrokes on a computer, or the timing of cars passing a certain point on the highway.

This invention thus combines the acquisition of truly random data from a myriad of continuous analog sources & methodologies/processes for organizing that data in a key server. The key server manages & distributes keys to trusted devices.

Key Server:

The key server stores sets of digitally sampled continuous true random data that may be accessed & organized in various ways. Unique keys could be distributed to millions of devices or sets of devices could use the same key set. These keys could be distributed locally to devices in a production process, or remotely to devices encoded using a public key cryptographic or modified public key cryptographic encryption technique (key protection by combining multiple forms of different kinds of encryption).

Unique Key:

Unique keys may be served by simply copying a random key set or a portion of a random key set from the key server to a trusted device.

In the simplest implementation the encoding or decoding of a message is performed by “XORing” the message & the random data recording (key), if the message is longer than the random data recording (key), simply continue by starting at the beginning of the recording again. Given two trusted devices & unique keys, this method is highly secure against eavesdroppers or spoof attacks.

If a unique recorded key is combined with varying access patterns the encode/decode process could change on an agreed upon basis; such as by time frame, message count, or other agreed basis.

Furthermore devices could have several different recorded unique key pairs such that messages could be shared with more devices, receive broadcast messages, or so that an operator could perform a secondary security function.

In the case of an operator performing a security function, he might be required to send a message using a different key once a day, if that message was not sent to other devices one day, the operators device could be flagged as “possibly being compromised” & any other messages sent by that device could be flagged as “suspect”.

Shared Key Set:

Devices may use key sets that are used by many devices (shared); shared keys would be very useful when broadcasting messages from one to many devices. Since the more devices sharing the same key increases the likelihood that one of these devices could fall into the hands of a hacker, broadcasted messages using shared keys could be restricted to lower security message trafficking or they could be combined with other techniques to increase the overall security of an encrypted broadcast based messaging system.

Shared key set implementations could also be combined with varying the access pattern of the recorded key data.

Key Serving:

Local Key Serving is the configuration of devices with sets of recorded random data keys while they are still in a secure environment, at the factory or configuration center. The key server could maintain a data base that tracks the keys & key access patterns that various devices support. Since maintaining secure key servers & respective data bases is of paramount importance, the data base files themselves could be encrypted as they were created, & possibly sent to other secure locations where that data could be maintained or used.

Remote Key Serving is the configuration of devices with sets of recorded random data keys in remote locations. In this case a device's keys could be changed or augmented. New keys could be added or new key access sequences could be downloaded into fielded devices. The main concern here is to minimize the possibility that a device's keys cannot be updated in the field by a hacker. Updating remote devices can be implemented using existing keys recorded on a device, yet if the device does not currently have these keys in its memory some form of public key exchange system could be used to transfer new keys to the device: in such a case foreknowledge of certain numbers (prime number, generator number, or secret numbers) by an operator or device would increase the probability of maintaining maximum security.

Data Structures within Key Servers:

Data stored within Key Servers may be organized within a variety of data structures. The key server may be used to maintain various sorts of information, including:

Recordings of Random Data “Keys”

Formulas for Access Pattern variation of the Recorded Random Data Keys

Certain numbers used to support public key exchange for remote key serving or updating access patterns

Data Base of device configuration

Encryption of data base information

Parameters required for guaranteeing of service

The Key server data base may be used to correlate device identification & configuration information as well as record messages sent & received by the key server. When this information is encrypted it may also be stored with additional information, a Header used to correlate or classify the data in a quick & efficient way. To increase security, the Header may require a different key than the data that is associated with that Header. Thus the key server could rapidly sort information & messages based on this Header information.

As an example, a key server contains 100 MB (104857600 Bytes) of random data sampled from radioactive decay. The server generates keys of 128 bits in length and is capable of generating at most (104857600*8-127)/128=6,553,599 unique keys with no shared (common) information between keys. The random data, if it were located on a 500 GB disk drive within the key server, would account 0.000013% of the capacity. If more than 6.5M keys are required, the key server could simply have more random data −1 GB of random data would supply 65M keys. Another alternative would be to index the random data and read addresses rather than keys. A key would be constructed by concatenating the random data at the addresses.

In addition to encrypting the data, the random data may also be used to determine the store location of data on the storage device. A simple hashing technique would obfuscate the location of the data and make re-assembly of large data sets difficult.

### BRIEF DESCRIPTION OF THE DRAWINGS

FIG. 1 shows a series of Digitized Random Data sets (1), and a Data Structure (2) that contains Configuration Information.

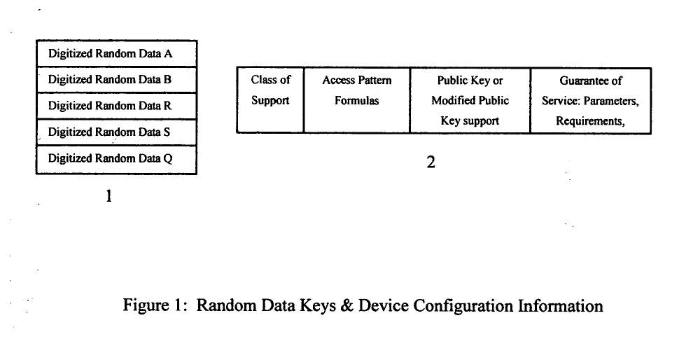

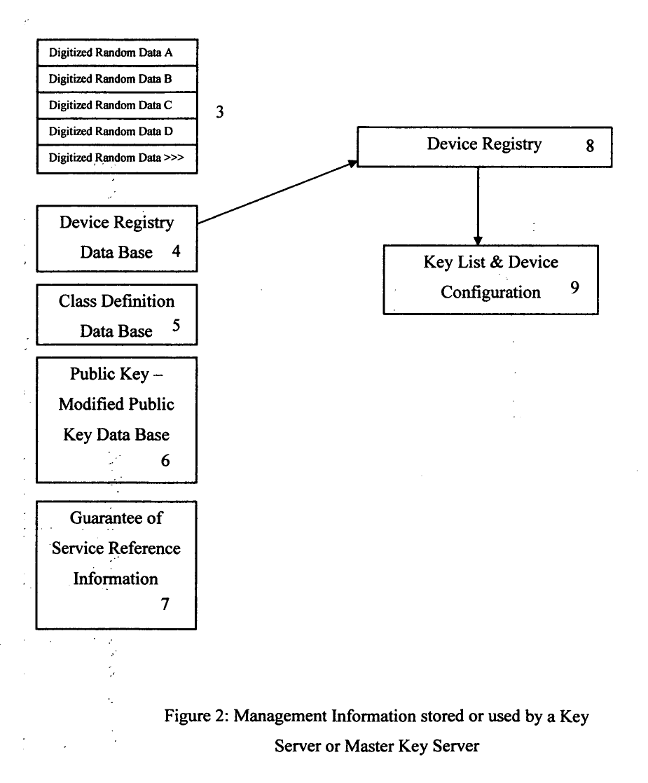

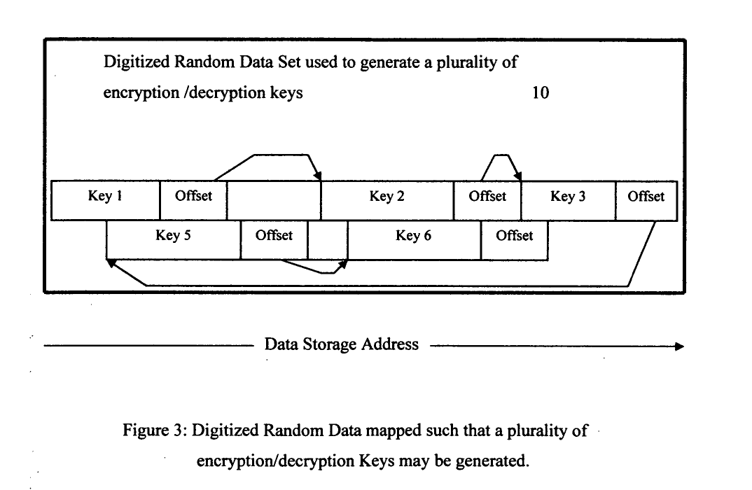

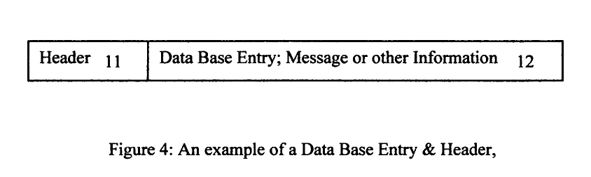

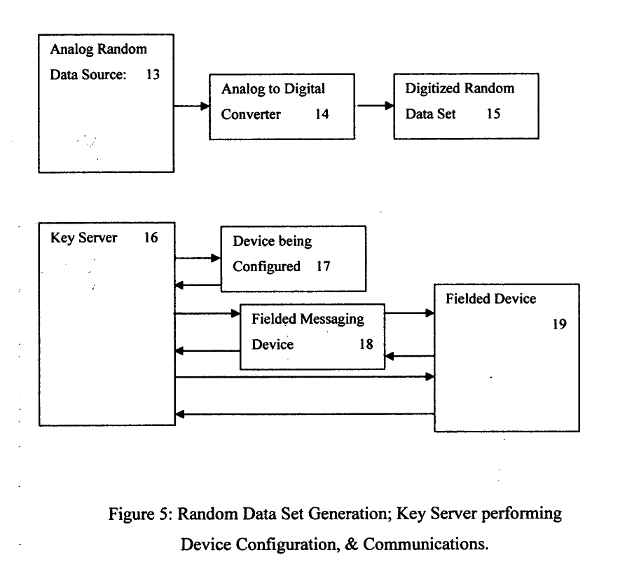

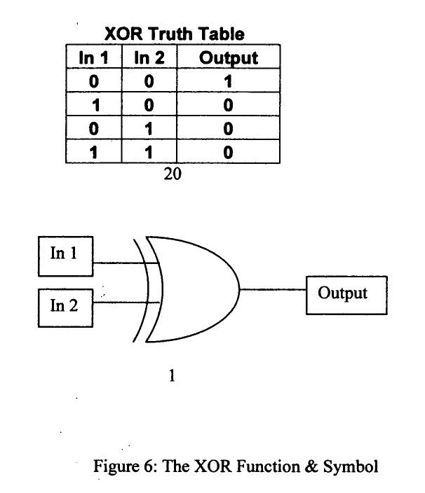

The figure contains five sets of Digitized Random Data {A, B, R, S, & Q} that are used to generate random data keys and to encrypt/decrypt computer data or messages.

The Data Structure (2) containing configuration information describes various capabilities of a device: Class of Support, Access Pattern Formulas, Public Key or Modified Public Key Support, and Guarantee of Service: Patterns, & Requirements. These various capabilities define the requirements for communicating with a device, between various devices, for updating a device, and by a device itself to perform secondary data security functions.

FIG. 2 shows management information that may be stored by a Key Server, information that may be used to setup, configure, and/or manage a plurality of fielded devices, including:

A plurality of Digitized Random Data sets (3) that may be used for distributing Keys to devices and/or for encrypting messages sent to devices.

The Device Registry Data Base (4) consists of a plurality of Device Registry Entries; each Device Registry Entry (8) contains Key List & Device Configuration Information (9). The information within the Device Registry Data Base (4) can be used to send and receive encrypted messages to fielded devices.

The Class Definition Data Base (5) contains a list that defines a plurality of possible device types/classes. For Example a device used only for communicating text messages could be a Class 1 device, and a device that transmits video & audio could be a Class 2 device. Furthermore a device with a limited life span could be a Class 20 device.

The Public Key—Modified Public Key Data Base (6) contains a list of various public key implementations supported by the Key Server. This information is useful when configuring, updating, and/or communicating with devices.

The Guarantee of Service Reference Information (7) contains a list of various service requirement configurations that are supported by the Key Server: This information is used as a secondary security measure, a device that does what is expected over time or that can provide special case passwords under special circumstances should be more trustworthy than a device that never behaves as expected. Examples of uses of Guarantee of Service Reference Information may be used to specify how frequently a device must be communicated with in order to remain a trusted device, may be used to specify when/how special case passwords or encryption keys may be used in order to remain a trusted device, or how a devices behavior must change over time to remain a trusted device; it's extensible.

FIG. 3 shows a single set of Digitized Random Data (10) mapped such that a plurality of encryption/decryption Keys may be generated. In this figure the address of where the random data is stored increases from left to right; such that Key 1 shares some of the same random data as Key 5 and Key 2 shares some of the same random data as Key 6.

FIG. 4 shows an example of a Data Base Entry (12) and Header (11) that may contain historical time based information such as a summary of or copies of messages sent to a device, or be used to track the status of a device. Here the Header is used to rapidly classify, and sort data base entries. To enhance security the Header (11) and Data Base Entry (12) may be encrypted with different Keys. Similarly messages sent to or received from a device may also include a Header and a Message that are encrypted with different Keys, if the Header contained a destination address, then the Message could be routed to the appropriate device by decrypting the Header and not the Message.

FIG. 5 shows how a Digitized Random Data Set is generated, shows that a Key Server can configure devices communicate with fielded devices, and shows that fielded devices can communicate with each other.

The Digitized Random Data Set (15) is generated by sampling a Random Analog Data Source (13) by an Analog to Digital Converter (14).

A Key Server (16) containing a plurality of Digitized Random Data Sets is used to Configure Devices (17), and communicate with Fielded Devices (18, & 19). Fielded Devices (18, & 19) may also communicate with each other.

FIG. 6 shows the Truth Table of the XOR Function (20) and the XOR Function Symbol (21); the output is generated by following the truth table; also if one of the inputs is XORed with the output, the other original input value is generated.

1. A data storage device having separate areas for the storage of user data and random data, where the separate area for random data contains digitized random data.

2. Claim 1 where the data storage device has additional facilities for the encryption and decryption of data.

3. Claim 2 where the data storage device creates a plurality of keys for encryption and decryption of data.

4. Claim 1 where only encrypted user data is stored in the user data area.

5. Claim 3 where the data storage device retains the encryption key and sends the decryption key to the user.

6. Claim 3 where the data storage device sends both the encryption and decryption keys to the user without storing either of the keys.

7. Claim 1 where the random data is sampled from a naturally occurring analog noise source and converted to digitized random data.

8. Claim 2 where the encryption & decryption are done using binary arithmetic XOR function.

9. Claim 3 where the storage device acts as a secure key server.

10. Claim 9 where the key server maintains a data base that contains a mapping of the keys within the storage device.

11. Claim 9 where encrypted data is stored within the data base.

12. Claim 9 where keys are used to authenticate users.

13. Claim 2 where information stored in user data area is organized with a database that partially decrypts a header portion of the information without decoding the remaining data in the information.

14. Claim 13 where the header is encrypted and decrypted with different keys than those used for user data encryption or decryption.

15. Method of encryption using digitized random analog data applied to user data within a storage device.

16. Claim 15 with decryption using digitized random analog data applied to user data within a storage device.

17. Claim 15 where the encryption is applied to the pattern of access within the data storage device.

18. Claim 15 where the method of random data encryption is combined with a public key cryptography method.

19. Claim 15 with user authentication prior to permitting access to the user data area of a data storage device.

20. Claim 15 with encryption applied to the location address of user data within a data storage device.
